(19) United States
(12) Patent Application Publication
(10) Pub. No.: US 2017/0028897 A1
(43) Pub. Date: Feb. 2, 2017

(54) Low speed transport docking station

(71) Applicant: Diverse Global Sourcing, Inc., Maple Lake, MN (US)

(72) Inventor: Ralph Pribyl, Maple Lake, MN (US)

(21) Appl. No.: 15/222,480

(22) Filed: Jul. 28, 2016

Related U.S. Application Data
(60) Provisional application No. 62/198,765, filed on Jul. 30, 2015.

(51) Int. Cl. B60P 3/10; B62D 29/00; B60G 17/005; B62D 63/06; B60G 17/00

(52) U.S. Cl. CPC B60P 3/1033; B62D 63/062; B60G 17/00; B60G 17/005; B60P 3/1066; B62D 29/008

(57) ABSTRACT

A low speed transport and docking system for a watercraft comprising a wheeled frame for supporting the watercraft and configured for transport over a land surface by way of at least one pair of ground engaging wheels and for docking the watercraft in and out of a body of water. The axle rotatably securing the ground engaging wheels to the frame comprises angled terminal end lengths such that the wheels are offset from the center length of the axle so that a winch system and locking mechanism together are operably connected to the axle for rotating the axle to adjust the height between the wheels and the frame such that the wheels are engaged with the ground while the frame height can be raised or lowered for transport and/or docking of the watercraft such that the watercraft can be docked in the water or on land and transported to and from water with a single system.

### CROSS-REFERENCE TO RELATED APPLICATION

This application claims priority to and the benefit of U.S. provisional patent application Ser. No. 62/198,765, filed on Jul. 30, 2015, the content of which is hereby incorporated in its entirety.

### BACKGROUND

The transport of watercraft to a body water and the docking of the watercraft in the body of water generally requires a trailer and a lift system which are separate pieces of equipment. Generally, a docking system of the prior art must be placed in the water near the shore line and secured thereto manually. Two or more people generally must move the dock to the water and position it along the shore for docking the water craft during between uses during the summer months or when the weather is warm enough for boating.

When moving the watercraft to and from storage, for example, in a shed or garage, a trailer for hauling the boat to and from the water is also needed. The trailer generally is moved to the water and submerged partially so that the watercraft may be loaded into the water at a selected water access point.

### SUMMARY

The present disclosure relates to a combined low speed transport trailer and personal watercraft or boat docking station. The low speed transport docking station can be used to transport personal water craft, boats, or the like to and from the water while also providing a docking station for the personal water craft, boat or other similar equipment in the water, for example near the shore line. Thus, the system is a single system for both docking and transporting the watercraft or boat.

The transport docking system of the present disclosure comprises a wheeled frame for rolling movement along a ground surface and for engagement with ground in a body of water. The top of the frame also comprises a plurality of guide wheels and bumpers for securing and guiding the underside of the water craft or boat on the upper facing surface of the transport docking system. The ground engaging wheels are secured to the frame via connection with an axle where the wheels are secured to terminal ends of the axle in an offset manner. This allows the wheels to be raised or lowered as the axle turns. A winch cable system is operably connected to axle or axles supporting the pair or pairs of ground engaging wheels and when wound or unwound, the axle or axles rotate and the wheels are raised or lowered respectively. This thus moves the frame up or down and allows the watercraft or boat to be stored in the water or to be removed from the water with the transport docking system.

### BRIEF DESCRIPTION OF THE DRAWINGS

FIG. 1 is a perspective view of a low speed transport docking station and frame.

FIG. 2 is a top view of the low speed transport docking system with a personal watercraft thereon in dashed lines for clarity.

FIGS. 3A and 3B are diagrammatic plan views of the raising and lowering system in the raised and lowered positions, respectively.

FIG. 4 is detailed perspective view of the safety latching mechanism.

FIG. 5 is a detailed perspective view of the offset axle and rotation/pivoting mechanism.

### DETAILED DESCRIPTION

The present disclosure is directed to a personal watercraft or boat docking station that is also a low speed transport trailer for moving the watercraft or boat to and from a body of water. The docking station is illustrated generally in the figures at 10.

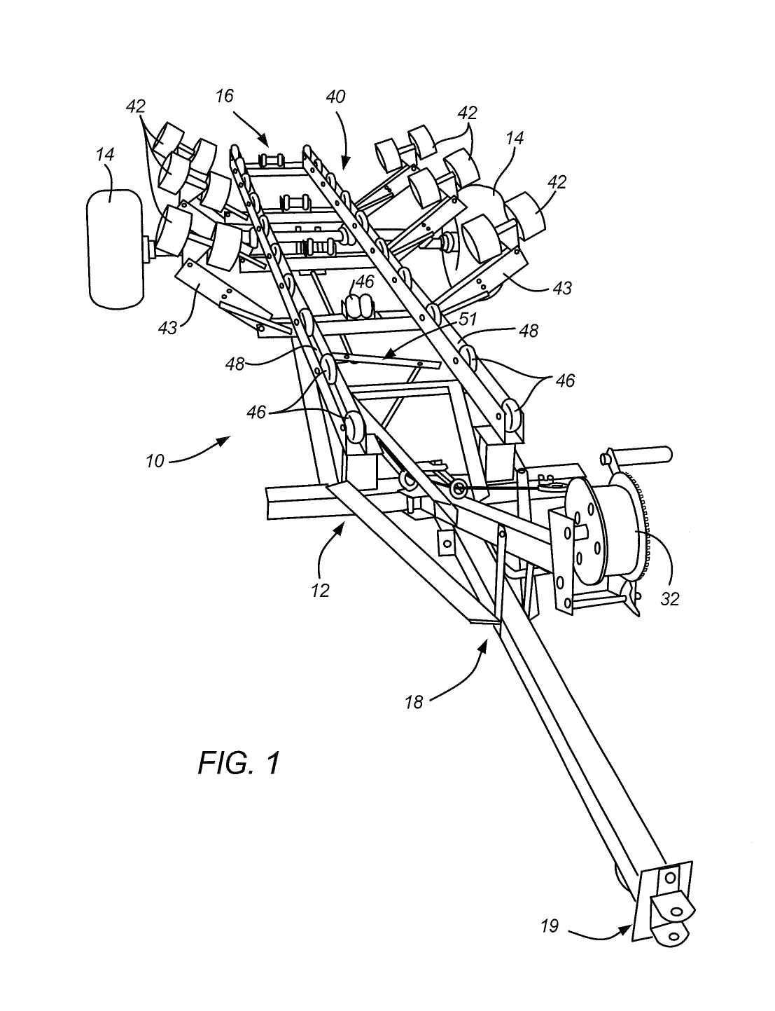

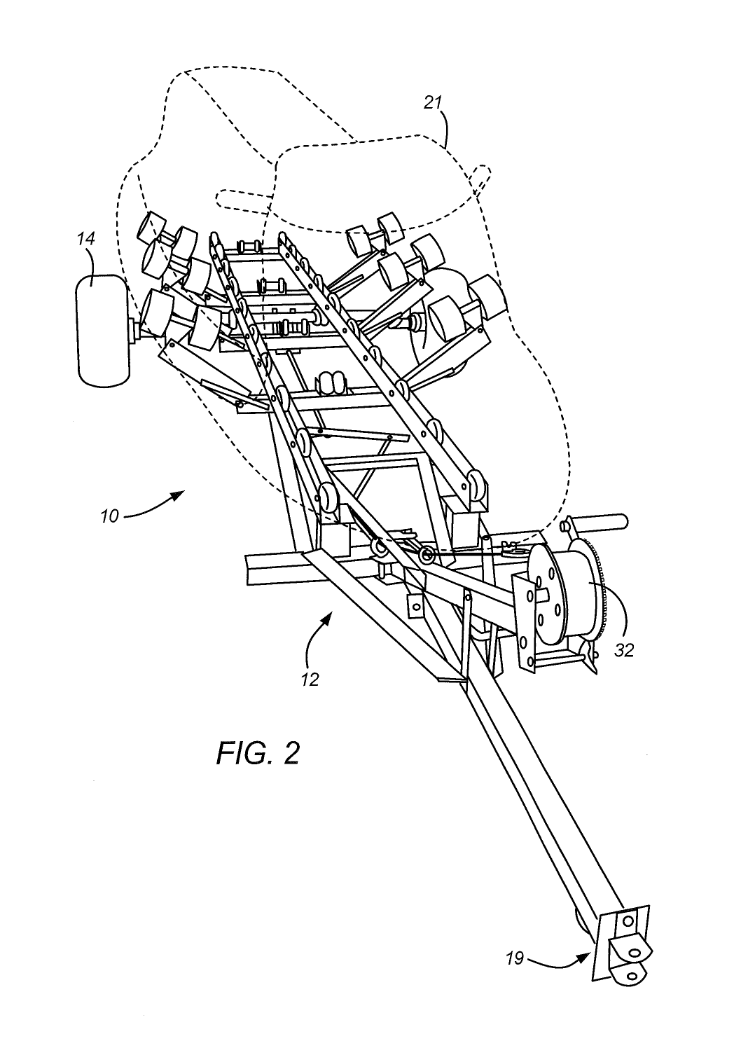

Referring first to FIGS. 1-2, the transport docking system 10 comprises a lightweight metal frame 12 comprised of aluminum or steel tubes. The frame 12 is a wheeled frame, meaning the frame is transportable over a land surface by way of at least one pair of ground engaging transport and docking wheels 14. The transport docking station 10 of the illustrated embodiment includes one pair of said transport and docking wheels 14. The wheels may be positioned near a loading end 16 of the frame opposite a towing end 18 of the frame 12. As the length of the transport docking station 10 can be increased or otherwise based on the size or length of the personal watercraft or boat 21, additional pairs of ground engaging transport and docking wheels 14 may be included and spaced apart from a first pair of wheels. Further, alternative configurations are contemplated and may be positioned based on the overall length and width of the transport docking station selected.

An end of the frame 12, opposite the loading end 16, is the connecting or towing end 18 which may be configured with a securing mechanism 19 for connection to an ATV, a tractor, automobile, or other device for transporting or towing the system 10. A personal watercraft, boat or other marine vessel 21 can be loaded onto the frame 12 for low speed transport to or from a body of water and the frame 12 is further configured for temporarily docking a watercraft in the water as well as for temporary and/or seasonal storage in and out of the water.

Referring to FIG. 2, the ground engaging transport and docking wheels 14 are positioned on terminal ends 24 and 26 of an axle 20. The wheels 14 are freely rotatable and thus are rotatably secured to the axle 20. The axle 20 is also rotatably or pivotally secured to the frame 12. Rotation of the axle 20 is allowed by connection mechanism 23 which connects the axle 20 to a winch and/or lever operated system for rotating or pivoting the axle 20. Rotating the axle 20 allows for raising or lowering the wheels 14 with respect to the frame (e.g. height-wise extending the wheels away from or retracting the wheels closer to the frame 12). For example, when the station 10 is positioned in the water and as the water level changes (e.g. rain storms, drought, moved position etc.) the axle 20 can be rotated such that offset wheels 14 can be raised or lowered with respect to the frame 12 such that as the wheels 14 remain engaged with the ground surface the frame 12 and thus the craft thereon 21 are adjusted height-wise with respect to a water level. In transport, the wheels 14 can be positioned at a standard height (e.g. not raised or lowered, instead the ends of axle 24 and 26 being at substantially the same height as center length 28) to make transport of the station 10 and any watercraft 21 thereon as easy as possible by reducing the force necessary for pulling the station.

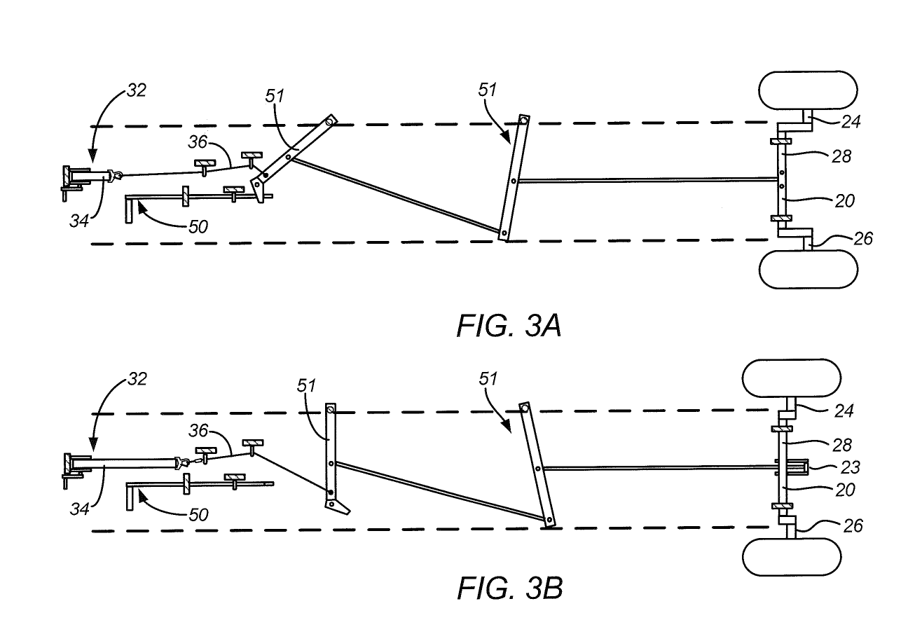

As illustrated in FIGS. 3A and 3B, the winch system 32 and a corresponding lever 50 are connected to a framework 51 which is movable or operable in order to selectively rotate axle 20 and to secure axle 20 in a selected position. The combination rotates the axle and locks the axle in any one of the rotated positions such that the axle may be locked with ends 42 and 26 in any rotated position with respect to the axle 20 and center length 28. As such, ends 24 and 26 may be positioned substantially extending upwardly or downwardly (above or below center length 28) and perpendicular to axle 20 as well as positions or orientations therebetween. This allows the user to selectively raise the wheels 14 with respect to the frame 12 or lower the wheels 14 with respect to the frame and to secure or lock the wheels 14 in said position, while the wheels remain freely rotatable. The ends 24 and 26 may be positioned such that the wheels 14 can be secured in any position including and between a fully extended and a fully retracted position depending on water levels or other factors.

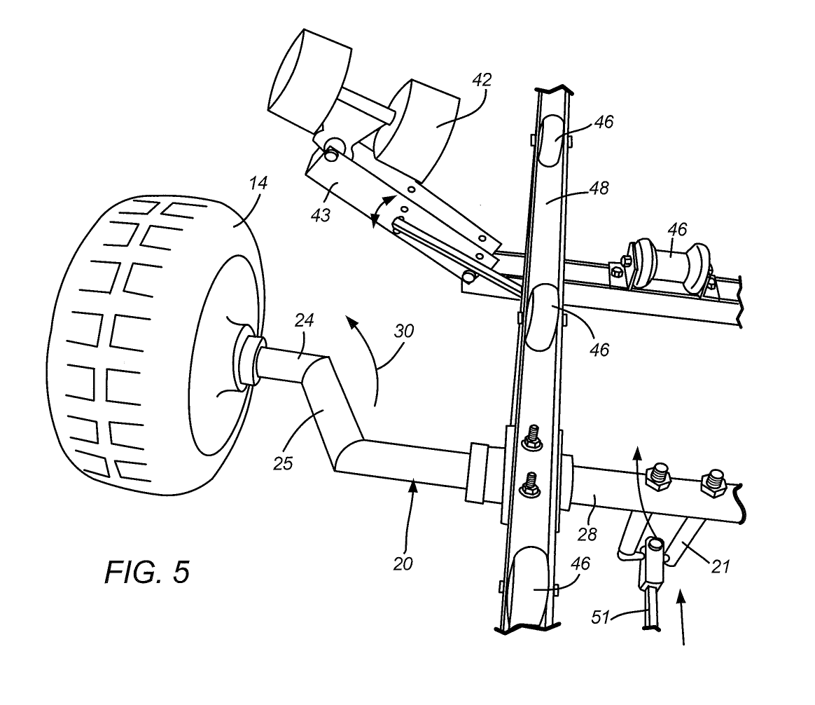

In further detail as illustrated in FIG. 5, the terminal ends 24 and 26 of the axle 20 are angled to extend away from a center length 28 of the axle. Thus, the rotatable connection of the wheels 14 to the axle 20 is an offset connection. The wheels are offset a distance according to the angular orientation and length of axle connection length 25, which connects length 24 of axle 20 to length 28 (e.g. center length 28) of the axle 20 in an offset manner. This allows the rotation of the axle 20 to raise or lower the wheels 14 respectively when the axle is rotated in reciprocal directions are illustrated by arrow 30. This allows the wheels to be positioned below the frame, substantially in plane with the frame or even slightly at or above the plane of the frame body and secured in the selected position. As noted previously above, rotating the axle to select the position of the wheels (e.g. height with respect to the frame) allows the frame 12 to be raised or lowered depending on its position in the body of water, depth of the body of water, or lowered for ease of transport of the frame 12 out of the body of water while the watercraft is secured thereon.

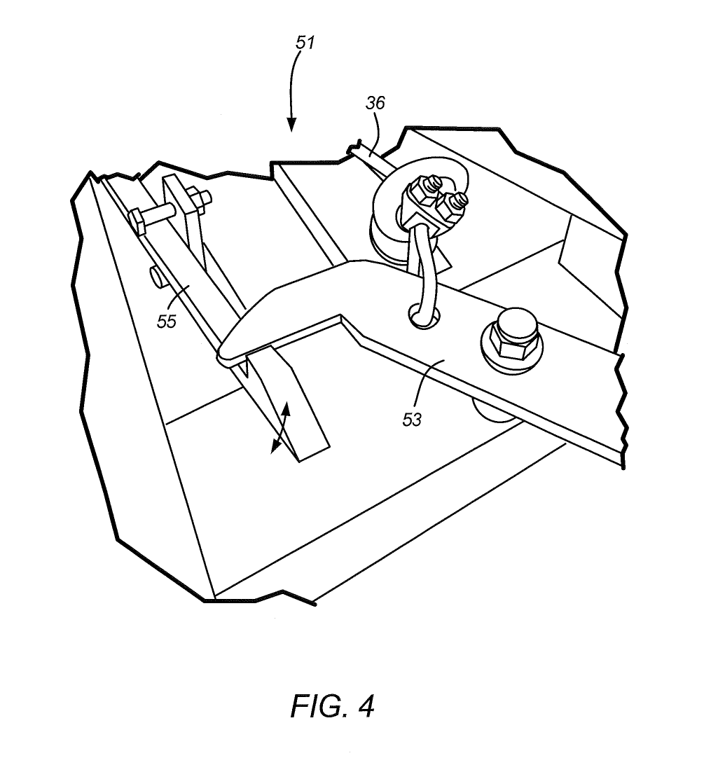

As illustrated in the figures, the winch system 32 comprises a winch 34 and cable line or rope 36 which extends along a length of the frame 12 and is operably connected to the axle 20 and thus the wheels 14 via rotation system 51. The winch system 34 comprises a cable line 36 having an end configured for connection to rotation system 51 which is connected to the center length 28 of the axle 20 via mechanism 21. System 51 comprises a network of pivotable components which are operably connected and thus configured to transfer the rotational movement of the winch from the cable along the length of the frame 12 to rotational movement of the axle 20. Lever 50 is also operably connected to system 51 to secure or lock the rotation system 51 in the selected position to secure the position of the axle 20. Referring back to FIG. 4, the lever system 50 is configured for locking the axle in the selected position as illustrated. Lever 50 secures the position of system 51 by engaging arm 53 with extension 55 to prevent movement. The winding of the winch 32 provides a counter force for holding the axle in the selected position. The winch system 32 can be wound or unwound to rotate the axle 20, which thus raises or lowers the offset wheels 14 with respect to the frame 12 and once the selected position is reached. Lever 50 is used to lock the position for storage or transport and subsequently to unlock the axle 20 from its position for adjustment.

A pulley system may be also be incorporated having an end configured for connecting to a front end of a watercraft for pulling and/or securing the watercraft onto the frame for storage in or out of water and for transport. The pulley system or additional winch may also be wound and unwound to pull the boat onto the frame 12 for loading and to release the boat for unloading respectively. The frame 12 can be placed in the water as a docking station and the watercraft or boat loaded thereon and stored during summer months for example. The frame 12, with or without the watercraft or boat, can then be pulled out of the water and/or moved across land with or without the watercraft or boat for storage.

A top surface 40 of the frame 12 may also comprise a plurality of smaller guide wheels 42 (e.g. “rollers”) which are rotatably secured to and protrude upwardly from the frame 12 for supporting the bottom surface of a watercraft or boat and for allowing the watercraft or boat to be easily loaded onto the frame 12. The guide wheels 42 may be positioned in pairs where the pairs are secured to ends of arms 43 that extend upwardly and outwardly from the frame 12 along the length of the frame 12. The arms 43 may be adjusted to accommodate personal water craft 21 of various sizes. The wheels 42 thus are positioned to contact the lower sides of the underside of the watercraft of boat 21. The pairs of guide wheels 42 are spaced apart along the length of the frame, along both opposing sides of the frame 12. The watercraft engaging wheels 42, or rollers, may be comprised of light weight heavy duty plastic or like materials and have a texture configured to provide frictional engagement with the underside of the watercraft. Thus, the frame 12, the ground engaging wheels 14 and watercraft engaging wheels 42 are light weight but sturdy. The wheels 42 allow the watercraft or boat to be easily loaded onto the frame and positionable on the frame 12 from a rear portion of the frame to the front of the frame for securing to the watercraft on the station 10.

Additional rolling or rotating wheels 46 may be positioned within guide rails 48 extending the length of the frame 12. These wheels 46 may be comprised of rubber or a like resilient material. The wheels 46 are also rotatably secured within the guide rails 48 and protruding upwardly therefrom to contact the bottom portion of the underside of the watercraft (for example, the lower apex portion of a watercraft). The wheels 46 are thus spaced apart along the length of the frame 12, along both opposing sides of the center or middle of the frame 12 although the wheels 46 may also be positioned along the center in various configurations. The wheels 46 aid in loading and unloading a watercraft 21 on the frame 12.

Although the description herein relates to single hull watercraft, it is also contemplated that structures for lifting pontoon boats may also be used with the transport docking system described herein.

In use, a personal watercraft or boat may be secured to the frame 12 for storage while the wheeled frame 12 is at least partially submerged in a body of water with a portion of the station engaged with the shore line or the bottom of the shallow portion of the body of water. The frame is also transportable to and from a body of water, with and/or without the watercraft or boat secured thereon. Thus, the station 10 may be positioned on the shore for docking the watercraft or boat between uses where the watercraft or boat can be secured to the station 10. The station 10 can further be towed from the shoreline with the watercraft or boat secured thereon.

An operator will move, or back the station 10 up to a body of water, for example, a shore line or beach. The operator may do so manually, by hand or alternatively with a small tractor, ATV, truck or other automobile for transporting the station 10 and docking the watercraft. The operator then lowers and uses the winch and lever system to unlock the axle rotation mechanism and rotates the axle to position the station as selected in or at least partially submerged in the body of water. When at least a portion of the station 10 is submerged in the water, generally the back portion where the watercraft would initially enter the frame, the watercraft or boat can be driven or steered directly onto and off of the frame for use or storage.

The transport docking station can remain at the shore line and at least partially submerged in the water while storing and securing the watercraft between uses to keep the watercraft safe during rising and falling lake levels due to storms, wind, and other environmental concerns. The position of the wheels 14 can be adjusted with respect to the frame as storage and/or transport conditions change or require.

When the watercraft is to be removed from the water, for example, during the fall and/or winter months, the watercraft can be docked on to the frame by securing the water craft to the front hook area of the frame. The winch is then unhooked and the locking mechanism unlocked. Repositioning of the wheels with respect to the frame such that the wheels are positioned close to or proximate (e.g. height) the frame height for easier transport requiring less force to move the frame and watercraft. The entire station can then be connected to a small tractor or ATV to remove the docking station and the water craft to a storage area away from the shoreline.

Although the present disclosure has been described with reference to preferred embodiments, workers skilled in the art will recognize that changes may be made in form and detail without departing from the spirit and scope of the disclosure.

1. A transport and docking station for a watercraft comprising:
a frame for supporting the watercraft, wherein the frame is a wheeled frame configured for transport over a land surface by way of at least one pair of ground engaging wheels and for docking the watercraft in or out of a body of water;
wherein the at least one pair of ground engaging wheels comprises two wheels positioned on terminal ends of an axle rotatably secured to the frame and where each wheel is connected to the axle at a position offset from a center length of the axle such that the rotation of the axle raises and lowers the wheels with respect to the frame.

2. The transport and docking station of claim 1 and further comprising a winch system operably connected to the at least one pair of wheels such that winding of the winch rotates the axle and the changes the height of the wheels with respect to the frame and to the ground.

3. The transport and docking station of claim 2, and further comprising a lever mechanism for locking the axle in a selected position of rotation.

4. The transport and docking station of claim 1 wherein the frame further comprises a plurality of arms extending upwardly and outwardly from a center portion of the frame and wherein at least one guide wheel is rotatably secured to a terminal end of each arm of the plurality of arms.

5. The transport and docking station of claim 4 wherein the frame further comprises at least one center rail having a channel therein wherein a plurality of guide wheels are spaced apart along a length of the channel and are rotatably secured within the channel for positioning the watercraft on the frame.

6. The transport and docking station of claim 1 wherein the frame is comprised of aluminum.

7. The transport and docking station of claim 1, wherein the terminal ends of the axle comprise a length angled away from the center length of the axle for rotatable connection with the ground engaging wheels.

8. A method of transporting and docking a watercraft comprising:
providing a frame for supporting the watercraft, wherein the frame is a wheeled frame configured for transport and docking by way of at least one pair of ground engaging wheels that are connected to an axle operable connected to the frame wherein each wheel is connected to the axle at a position offset from the axis of a center length of the axle such that the rotation of the axle raises and lowers the wheels with respect to the frame;
positioning the watercraft on top of the frame;
winding or unwinding a winch having a cable system and locking mechanism operably connected to the axle and positioning the ground engaging wheels in contact with the ground for transport of the frame and watercraft to a body of water; and
winding or unwinding the winch to raise or lower the frame 12 while positioning the ground engaging wheels in contact with the ground in the body of water for docking the frame at least partially submerged in the body of water.

9. The method of claim 8 wherein the frame further comprises a plurality of arms extending upwardly and outwardly from a center portion of the frame and wherein at least one guide wheel is rotatably secured to a terminal end of each arm of the plurality of arms.

10. The method of claim 8 and positioning the watercraft on top of the frame further comprising at least one center rail having a channel therein wherein a plurality of guide wheels are spaced apart along a length of the channel and are rotatably secured within the channel for positioning the watercraft on the frame.

11. The method of claim 8 wherein the frame is comprised of aluminum.

12. The method of claim 8, wherein the terminal ends of the axle comprise a length angled away from the center length of the axle for rotatable connection with the ground engaging wheels.
